(19) United States
(12) Patent Application Publication
(10) Pub. No.: US 2016/0267807 A1
(43) Pub. Date: Sep. 15, 2016

(54) METHOD AND ARTICLES FOR CONSTRUCTING A STORY

(71) Applicant: Patrick Moreau, Portland, OR (US)

(72) Inventor: Patrick Moreau, Portland, OR (US)

(21) Appl. No.: 15/064,394

(22) Filed: Mar. 8, 2016

Related U.S. Application Data
(60) Provisional application No. 62/130,550, filed on Mar. 9, 2015.

(51) Int. Cl. G09B 19/00

(52) U.S. Cl. CPC G09B 19/00

(57) ABSTRACT

A method for discovering the parts of a narrative and Constructing it into story. The parts include people, places, plot and purpose. Preferably the story is based on a singular main character who will lead the audience to the purpose. This allows the audience to understand and connect with the story, thereby facilitating the impact of the narrative presented.

### RELATED APPLICATION

This application claims the benefit of U.S. provisional patent application Ser. No. 62/130,550, filed Mar. 9, 2015, which is incorporated by reference herein in its entirety.

### BACKGROUND OF THE INVENTION

1. Field of the Invention

This invention broadly relates to methods and articles for use in constructing a story. More particularly, this invention pertains to a step-by-step method that includes a listening phase and constructing phase for understanding and presenting a story. It has a direct application in film and video production, but is also useful in marketing and brand positioning.

2. Description of Related Art

Storytelling is a specific form of communication. It involves the discovery and presentation of an account of people and the events they experience. Stories typically are told for documentary or entertainment purposes, or both. They can also be useful in education and marketing.

In a story people, known as characters, are the vehicle by which the story is told. A story also involves places, or settings, in which the narrative takes places. These two parts work in conjunction with a plot, or conflict, to guide the audience through a sequence of events to communicate a purpose, that is, a reason for the narrative. Together these parts are typically referred to as the building blocks of a story, or pillars of a story.

Conventionally, a story utilizes people, places and plot in a traditional three-act structure to convey a narrative. Storytelling can be advantageous because the effectiveness of a well-told story can have significant social, financial and personal benefits. Moreover, a clear method for constructing a story can be applied in many different fields of communication, using various media to create a useful story for a variety of purposes.

However, standard, clear and repeatable methods by which the parameters of a story are discovered and shaped to construct the story have not previously been available. Consequently, there has been a need in storytelling for practices that employ a clear, distinct, repeatable method for understanding characters, settings and motivations, and using that understanding to construct a story.

### SUMMARY

A method for constructing a story is provided, comprising listening to one or more persons to distill information into a narrative characterized by people, places, conflict and keywords; compiling respective lists of potential qualities of the people, places where those qualities manifest, conflicts the people may experience and keywords that represent a purpose that apply to the people, places and conflicts; constructing the narrative using the lists of the qualities of the people, the places, the conflicts, and the key words to select the heart and build the arc of the story; and expressing the identity of the people and the places, the conflicts, the keywords, the qualities and the narrative.

A series of worksheets for use by a person to construct a story is also provided. The series of worksheets have a portion corresponding to a listening phase and a portion corresponding to a constructing phase. The portion of the series of worksheets corresponding to the listening phase comprises at least one character page having a chart thereon with spaces for the name of a character and to be inserted and for one or more unique characteristics of that character, one or more desires of that character and one or more complexities of that character to be inserted; at least one conflicts page having a chart thereon with spaces for conflicts experienced by that character to be identified; at least one key word page having a chart thereon with spaces for a plurality of key words associated with each character; and at least one most significant key words page having a chart thereon with spaces for at least one of the most significant key words. The portion of the series of worksheets corresponding to the constructing phase comprises at least one ranking page for entering rankings of characteristics of a plurality of characters; at least one page having a chart for recording the lead character with that character's most significant characteristics; at least one page having a chart for entering the time, place, situation and environment in which the lead character lives; and at least one page having a chart for entering a sequence of steps from conflict to resolution of the story.

A method for teaching how to construct a story is also disclosed, comprising providing a graphical representation of a listening phase and a constructing phase. This method comprises providing a series of worksheets having a portion corresponding to a listening phase and a portion corresponding to a constructing phase. The portion of the series of worksheets corresponding to the listening phase comprises at least one character page having a chart thereon with spaces for the name of a character and to be inserted and for one or more unique characteristics of that character, one or more desires of that character and one or more complexities of that character to be inserted; at least one conflicts page having a chart thereon with spaces for conflicts experienced by that character to be identified; at least one key word page having a chart thereon with spaces for a plurality of key words associated with each character; and at least one most significant key words page having a chart thereon with spaces for at least one of the most significant key words. The portion of the series of worksheets corresponding to the constructing phase comprises at least one ranking page for entering rankings of characteristics of a plurality of characters; at least one page having a chart for recording the lead character with that character's most significant characteristics; at least one page having a chart for entering the time, place and environment in which the lead character lives; and at least one page having a chart for entering a sequence of steps from conflict to resolution of the story. The method also comprises guiding students through the use of the worksheets.

It is to be understood that this summary is provided as a means for generally determining what follows in the drawings and detailed description, and is not intended to limit the scope of the invention. The foregoing and other objects, features, and advantages of the invention will be readily understood upon consideration of the following detailed description taken in conjunction with the accompanying drawings.

### BRIEF DESCRIPTION OF THE DRAWINGS

FIG. 1A is a first part of the Figure referred to hereinafter as FIG. 1, which is a flow diagram of a preferred embodiment of a method for understanding and constructing a story in accordance with the present invention.

FIG. 1B is a second part of FIG. 1.

FIG. 2A is a front exterior of a preferred embodiment of a series of worksheets for use in implementing the preferred method of FIG. 1 as it relates to a people pillar of the story according to the present invention.

FIG. 2B is a graphical representation of 4 pillars of the story according to the present invention, specifically people, places, purpose, and plot.

FIG. 2C is a first worksheet in a people series of worksheets according to the present invention, with prompts related to a Listen phase according to the invention that guide a user to uncover characteristics of a character, specifically the character's desires.

FIG. 2D is a second worksheet in the people series of worksheets, with prompts related to the Listen phase that guide the user to uncover characteristics of the character, specifically the character's uniqueness.

FIG. 2E is a third worksheet in the people series of worksheets, with prompts related to the Listen phase that guide the user to uncover characteristics of the character, specifically the character's complexities.

FIG. 2F is a fourth worksheet in the people series of worksheets, with prompts related to the Listen phase that guide the user to naming the character, the character's characteristics, the places in which the character appears and potential conflicts that may arise.

FIG. 3A is a front exterior of a preferred embodiment of a series of worksheets according to the present invention for use in implementing the method of FIG. 1 as it relates to a plot pillar of the story according to the present invention.

FIG. 3B is a first worksheet in a plot series of worksheets according to the present invention, with prompts related to a Construct phase that guide a user to choose the heart of a story and rank order their prospective hearts' based on characteristics and keywords.

FIG. 3C is a second worksheet in the plot series of worksheets, with prompts related to the Construct phase that guide the user to build out the heart of the story by listing the heart's characteristics in detail.

FIG. 3D is a third worksheet in the plot series of worksheets, with prompts related to a Listen phase that guide the user to build out the heart of the story by listing details for a typical day.

FIG. 3E is a fourth worksheet in the plot series of worksheets, with prompts related to the Construct phase that guide the user to build out a single Core Question, comprising an Ask, Acceptance and Answer according to the present invention.

FIG. 3F is a fifth worksheet in the plot series of worksheets, with prompts related to the Construct phase that guide the user to build out a Hook and Jab of the story according to the present invention.

FIG. 4A is a front exterior of a series of worksheets for use in implementing the method of FIG. 1 as it relates to a purpose pillar of the story according to the present invention.

FIG. 4B is a first worksheet in a purpose series of worksheets according to the present invention, with prompts related to both the Listen and Construct phases, guiding the user to brainstorm and select keywords to use as a basis of the story's purpose.

### DETAILED DESCRIPTION OF EMBODIMENTS OF THE INVENTION

1. Glossary

As used herein:

“Acceptance” means that the main character within the story chooses to take on and overcome the conflict.

“Answer” means the resolution to the core question within the story.

“Arc” means the structure of the story as determined by the core question.

“Ask” means the core question that the conflict causes for the main character within the story.

“Conflict” means the type of challenge around which a story is built and the foundation of the plot that carries the story. The conflict gives the journey a direction.

“Construct” means creating, building or formulating a story.

“Core Question” means the central question that creates the arc of the story. It comprises an ask, acceptance, and an answer.

“Heart” means the singular principal character of a story who will lead to the Heart's string.

“Heart's String” means the person, product, service, issue, or idea that provides the impetus for creating and sharing the a story.

“Hook” means the beginning of a story that is designed to create intrigue and pull the audience in. The Hook should give the audience a reason to follow the rest of the story.

“Jab” means an end to a story that leaves the viewer with a clear call to action that is relevant to both the Heart's String and the Keywords of the story.

“Keyword” means one or more words used to represent what the story is intended to say to the audience.

“Listen” means to endeavor to deeply understand the Heart's String, the person, product, service, issue, or idea, in addition to understanding the context surrounding the Heart's String.

“People” means multiple persons.

“Person” means a character through which a story is told, the person having specific qualities including complexity, uniqueness and desire.

“Place” means a time, place, situation, or environment, including objects, in or with respect to which all or a portion of a story takes place.

“Plot” means the overall arc in which a story is told, including events that make up the beginning, middle and end of the story narrative.

“Purpose” means the reason for why the story needs to be told, why it is important, or what makes it meaningful to the audience.

2. Description

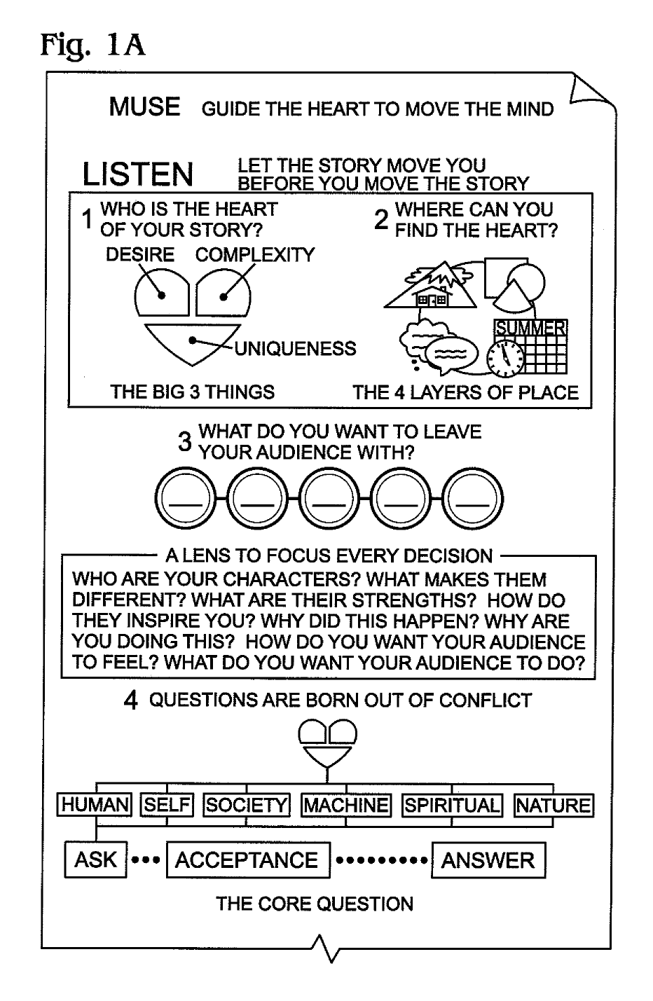

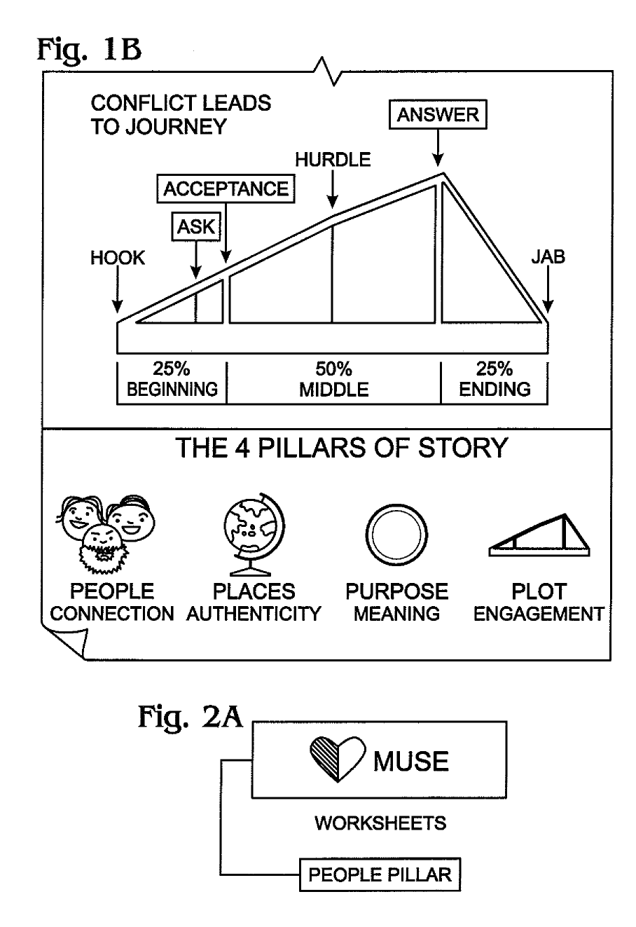

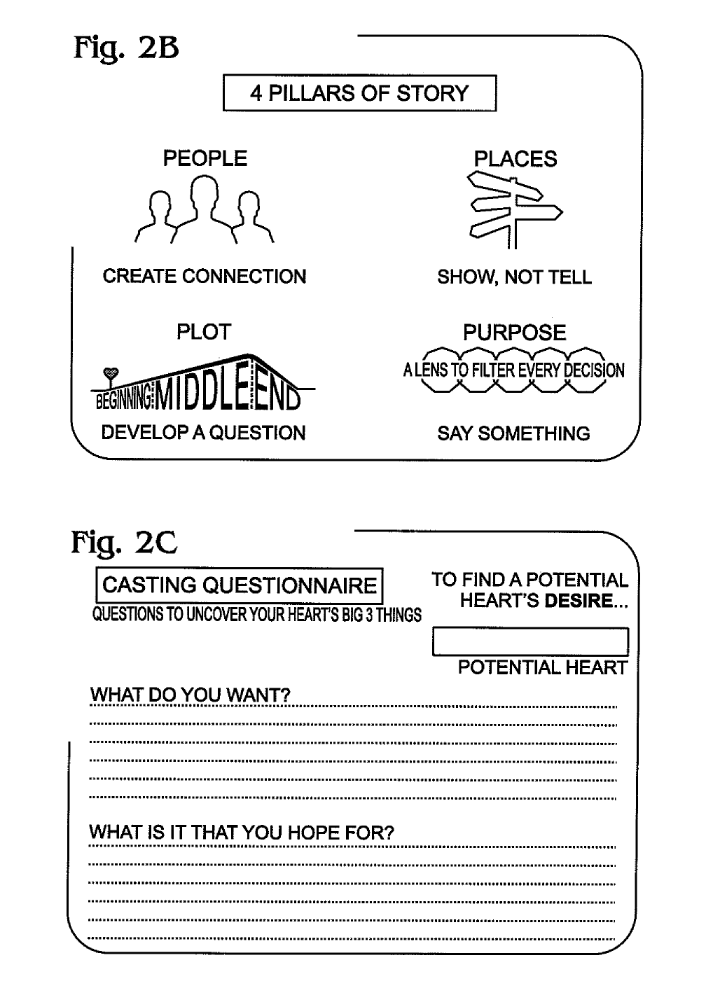

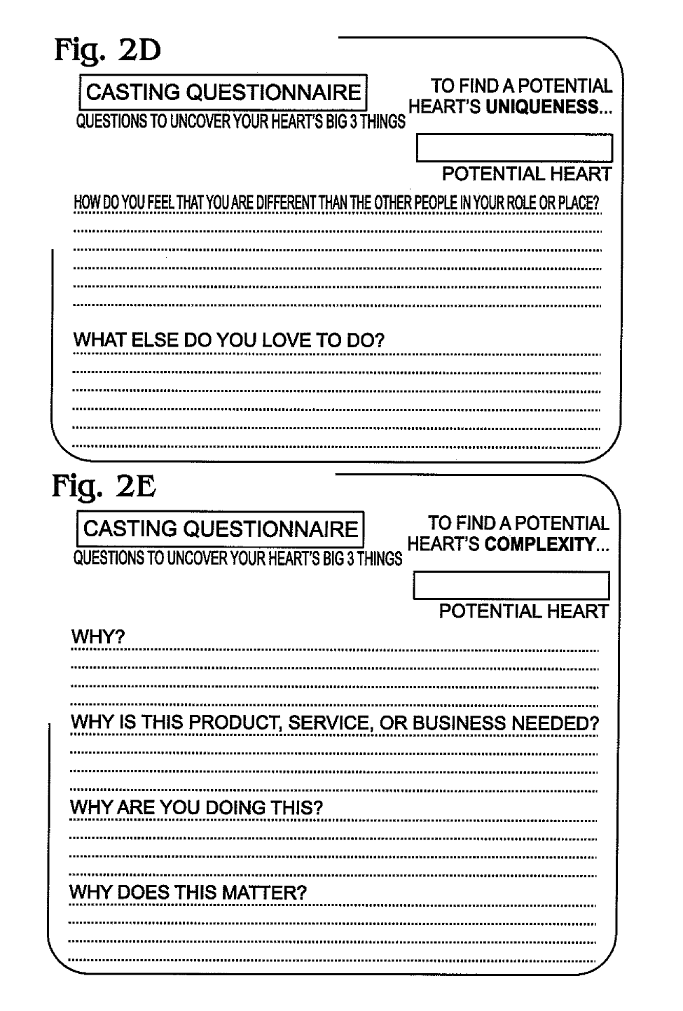

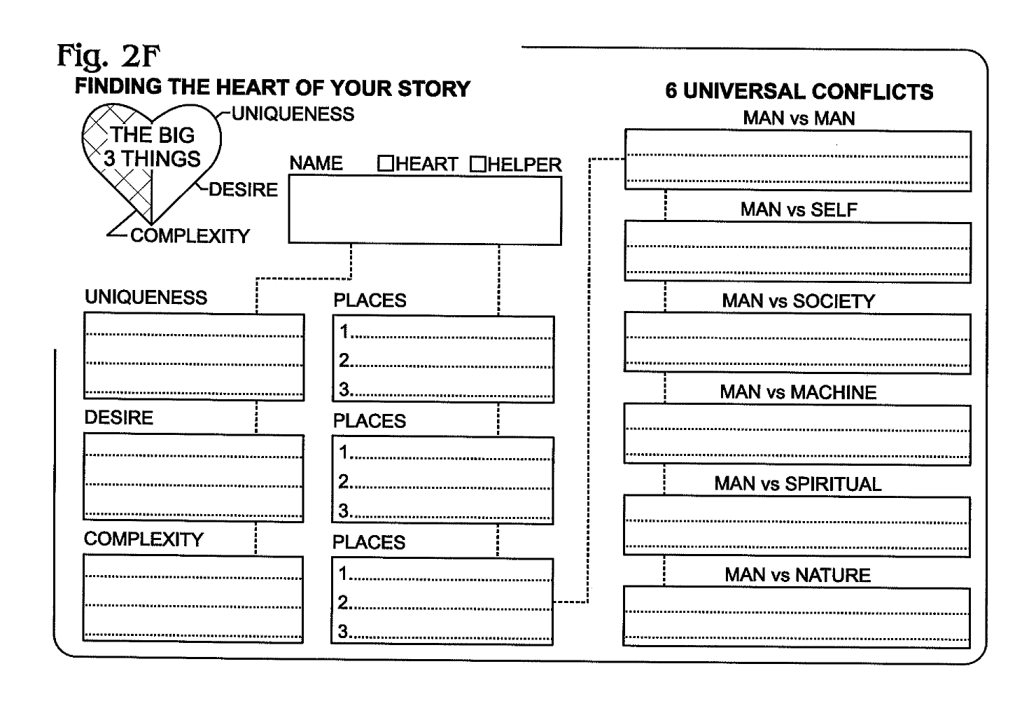

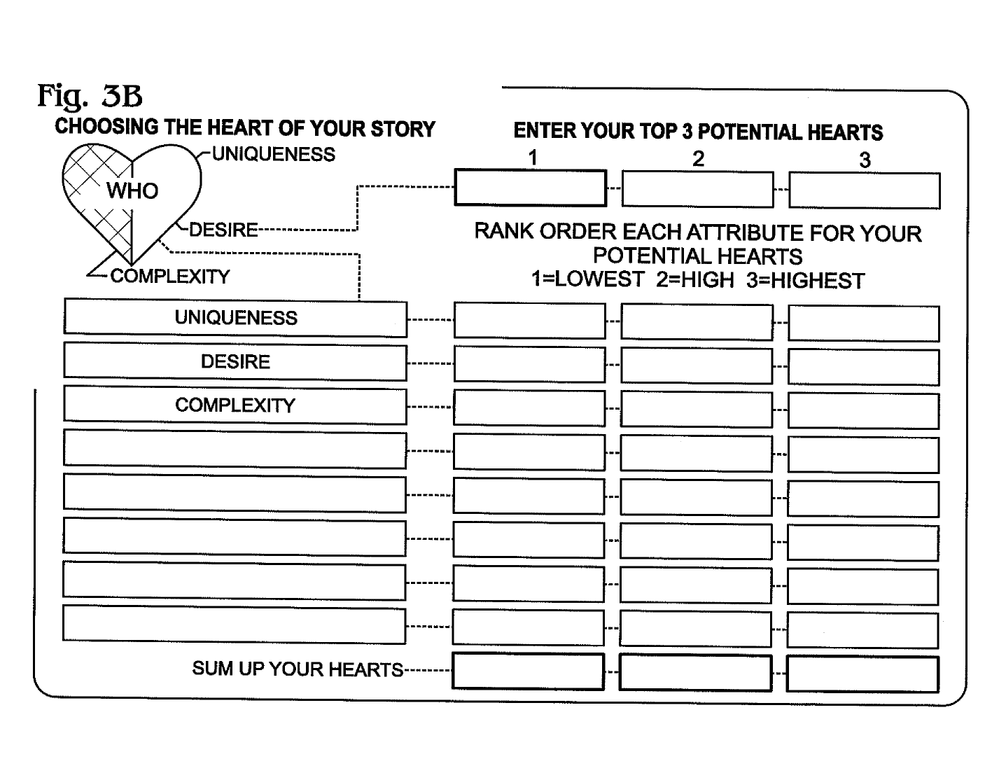

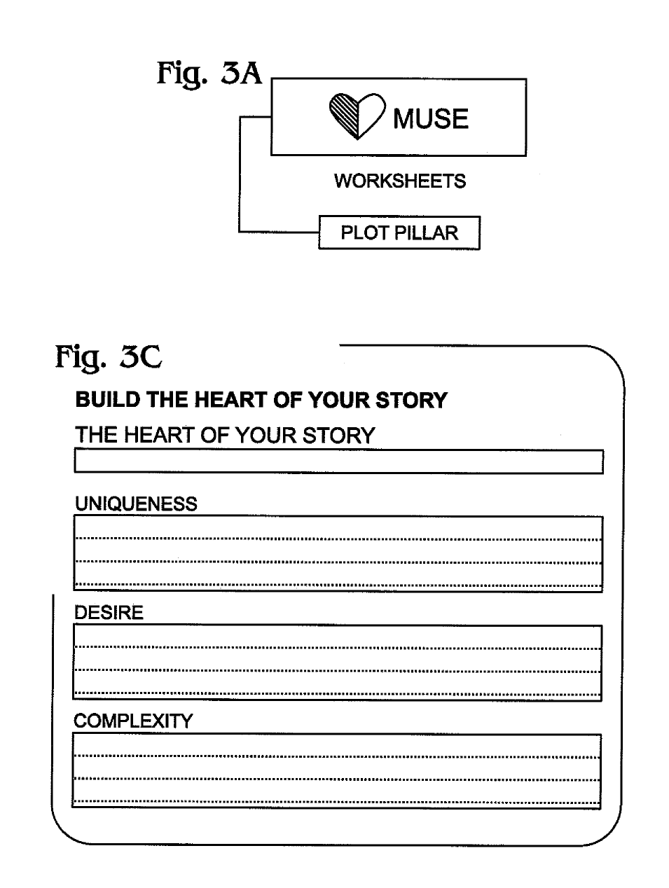

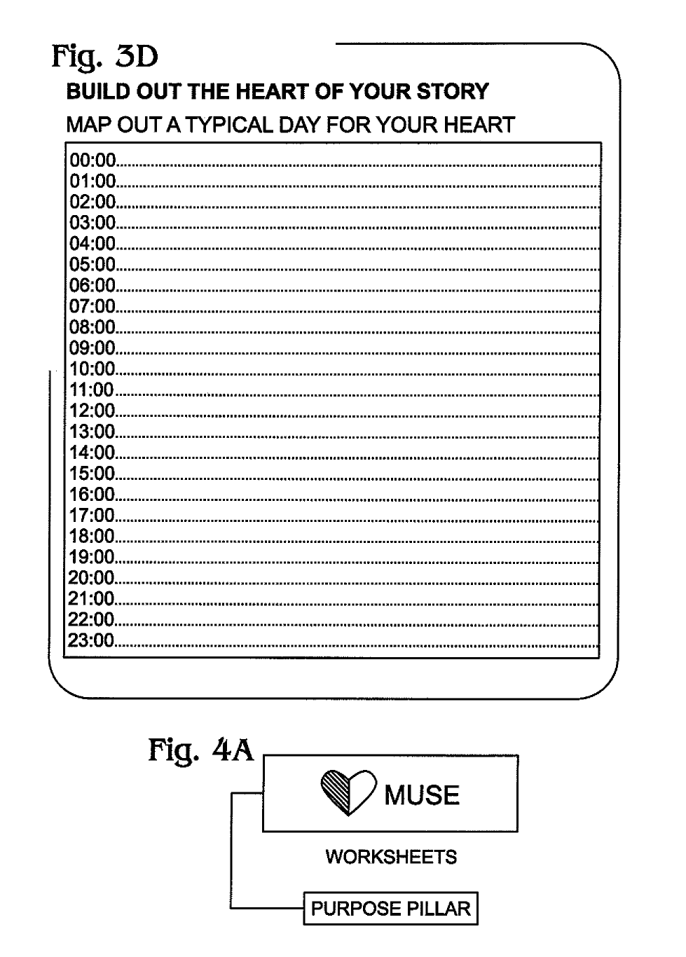

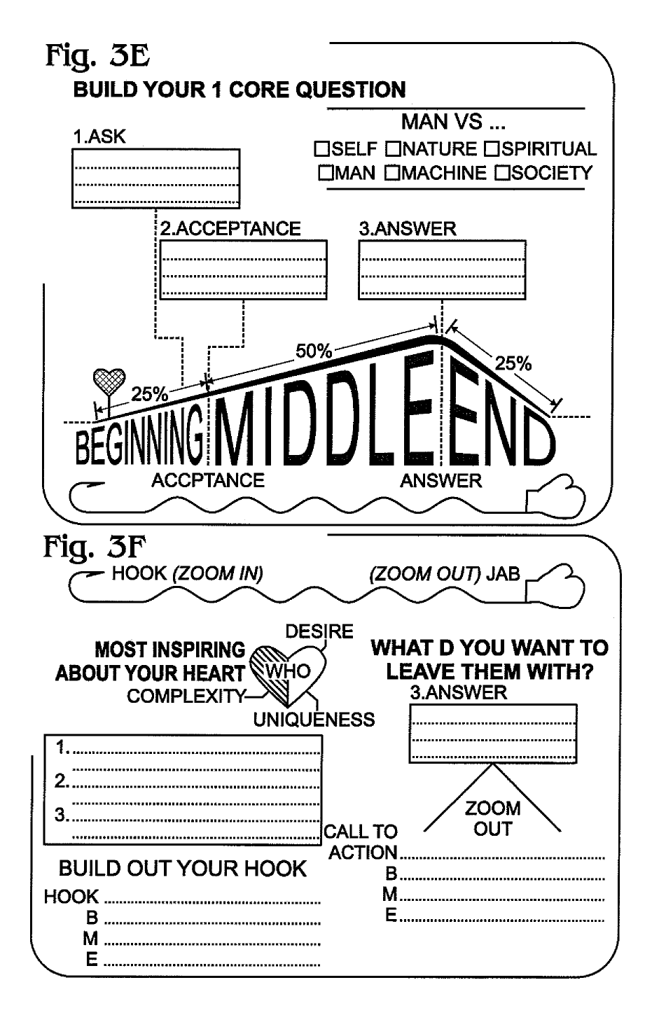

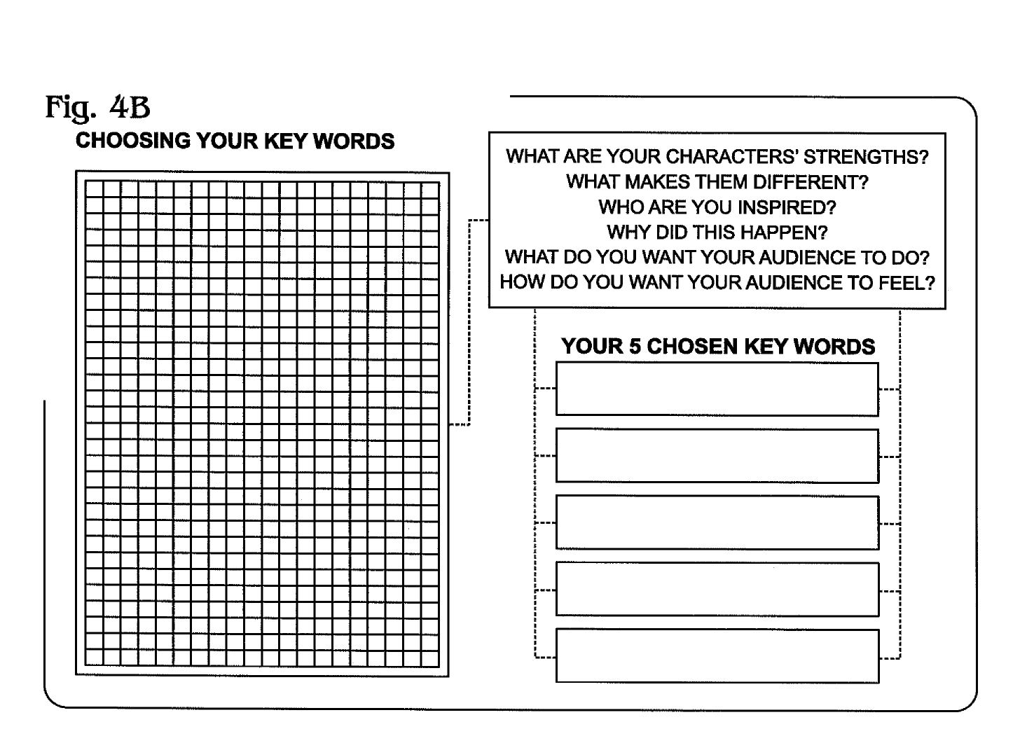

In one aspect, the present invention comprises a method for constructing a story that preferably includes 4 pillars, specifically referred to as people, places, purpose and plot, which represent two phases, a listening phase and a constructing phase. As shown in FIG. 1, during the listening phase the storyteller takes note of what makes the story interesting, that is, the characters (“WHO IS THE HEART OF THE STORY?”), where the story takes place “WHERE CAN YOU FIND THE HEART?”), the reason for telling the story (“WHAT DO YOU WANT TO LEAVE YOUR AUDIENCE WITH”) and how the story progresses (“QUESTIONS ARE BORN OUT OF CONFLICT”). In the constructing phase the storyteller takes the information gathered in the listening phase and constructs the best way to communicate that story. See FIG. 3B (“CHOOSE YOUR HEART”), FIG. 2F (“FIND WHERE COMPLEXITY, UNIQUENESS AND DESIRE LIVE”), FIGS. 3E and 3F (“BUILD OUT YOUR 1 CORE QUESTION”) and FIG. 4B (“YOUR 5 CHOSEN KEYWORDS”).

The listening phase preferably includes understanding and distilling information into the four distinct parts, or pillars, of a narrative noted previously, i.e. people, places, conflict (plot) and keywords (purpose). A list of potential qualities or descriptors that apply to story is compiled. This enables the storyteller to narrow down the specifics of each such part of the story, thereby providing a clear, distinct and repeatable process by which to determine each of four components of the listening phase.

The constructing phase preferably includes building and formulating the story narrative based on people, places, plot and purpose. This may use the conflict and keywords derived in the listening phase as a filter to select the people and places used to build the plot, or arc, of the story.

In another aspect, the present invention comprises a series of worksheets for implementing the method described herein, such as shown in FIG. 2A, which shows the front cover of a people series of worksheets, and FIG. 3A, which shows the front cover of a plot series of worksheets, and FIG. 4A, which shows a front cover of a purpose series of worksheets.

It is to be understood that it is a function of these series of worksheets in providing a relevant structure for organizing and recording the progress of the Listen and Construct phases of the preferred method that is important, and that the scope of the invention is limited only be the claims, not the specific wording or arrangements of regions of the charts in the specification.

A preferred method for constructing a story in accordance with the present invention is illustrated in FIG. 1, and preferred series of worksheets are illustrated in FIG. 2C, FIG. 2D, FIG. 2E, FIG. 3C, FIG. 3D, FIG. 3E, FIG. 3F, FIG. 3G, and FIG. 4C. These series of worksheets can be used to guide the storyteller through the method for constructing a story with a series of prompts. The storyteller is prompted by the series of worksheets to express the different parts of the story by writing them in the worksheets, and thereby implement the method. However, it is to be understood that, in the broadest sense, the different parts could be expressed verbally, writing them on a blackboard or whiteboard, entering them into a computer or any other means of manifesting practice of the method disclosed herein.

It is also to be understood that, while physical series of worksheets are disclosed herein, the functions of the series of worksheets could be carried out in other ways, such as charts on separate sheets in a notebook or by a computer programmed to present substantially the same organization and prompts as the series of worksheets, without departing from the principles of the invention.

In a preferred embodiment, The preferred invention is made up of a process is employed to find the best way to create a story from start to finish. The process preferably includes two phases: Listen and Construct.

The first phase is directed to listening to the story. Preferably this involves listening to the people participating in the story, expressing what makes this story interesting, determining who the characters are and what makes them compelling for an audience, determining where the story takes place and determining reasons for telling the story. After listening and considering the story as it presents itself, the storyteller can begin to construct the best way to tell that story. That is achieved through the four pillars of story: People—the characters who make up the story, Places—the environments, symbols, situations, and time of a story—the context in which a story is placed, Purpose—the journey, rising tension, climax and resolution of story, and Plot—the real reason a story needs to be told, why it is important to not only the people in the story but to a larger audience, it is purpose that will ultimately make a story meaningful to the world at large.

It is preferable to spend time with each phase, first in listening to the story that exists and then constructing the story in a way that can be easily appreciated by any audience. The goal is to make stories that are universally compelling, for the widest audience possible. This preferably starts with listening for the people, places, purpose and conflict of the story.

People—Finding the Heart of the Story

To find the heart of the story the storyteller may explore three qualities that make a person a compelling character. First, a character should be unique—because in the present method it is understood that human beings tend to notice the unusual. In the present method unique qualities are used to “hook” an audience. Second a character should be complex. In the present method it is understood that a character needs to be multifaceted to be interesting over the course of an entire story and that people who are complex are interesting. Ideally, as the story evolves with time and in space the characters will reveal a new or unexpected aspect of their being. Complexity is assumed not just to be a thing that resembles their uniqueness or their desire, but an internal struggle the character already exhibits before the journey begins. The present method employs the exploration of complexity that makes a character worth watching. Third, the method calls upon the character to have desire. In order for a story to occur the character has to want something. That desire is used by the present method to guide the journey of the story. It is assumed that conflict depends on desire. The character does not even have to know what it is that they want to want something. Determining what a character wants may by itself be the journey. These qualities may then be noted in sections corresponding to FIG. 2C, FIG. 2D, FIG. 2E in the people series of worksheets.

Places—Finding Where the Story Takes Place

In preferred embodiments of the present method, stories are about people who live in the physical world, that is, the world of time and space, having physical details, objects and symbols that enrich the story. The method allows historical context or time of day to give an audience a better sense of where the story takes place. Such details allow an audience to understand the characters in a story because they ground the story in reality. In this method place is used to show an audience instead of telling an audience what the story is about and thereby reveal to the audience the truth of a story. The method uses qualities that refer to the place or context of the story, and the series of worksheets guide the storyteller to express this information by recording it in sections corresponding to FIG. 2F.

Conflict—Finding the Heart's Journey

The People pillar relates to desire and the character of the story wanting something. But a story would not be very interesting if the character wanted something and then walked right out and got it. It's far more interesting to have to overcome obstacles. To identify the possible conflicts that exist in the story the present method posits 6 universal conflicts: Man vs. Man, Man vs. Self, Man vs. Machine, Man vs. Society, Man vs. Nature, Man vs. Supernatural, where “Man” means a Person and is gender neutral. The possible conflicts as they apply to the story may be expressed in the sections of the series of worksheets shown in FIG. 2F.

Purpose—Key words that Best Represent the Story

In the present method, multiple key words—preferably five key words—are chosen to best represent the story and act as a lens to filter every decision in the Construct phase. To determine the keywords the method challenges the storyteller with the following questions: Who are your characters? What makes them different? What are their strengths? How do they inspire you? Why did this happen? Why are you doing this? How do you want your audience to feel? What do you want your audience to do? The method promotes brainstorming words that could represent the answers to those questions and preferably expressing at least 20, and more preferably 30 or more, words before starting to narrow the list down to just five key words. These keywords in the final list should be used repeatedly throughout the storytelling process, so it is important that they are the words that best represent the story being told. All the 20-30 or more words and the subsequent 5 selected keywords may be recorded in the sections of the series of worksheets shown in FIG. 4B.

Once a group of, preferably, at least 20 words has been identified, the words may be grouped into clusters that naturally relate to one another. This helps to identify important themes and to select the right words for the story.

That may be considered to complete the Listen phase. A preferred Construct phase is described hereafter.

People—Choosing the Heart of the Story

In this step the storyteller may use the final keywords (preferably five) to choose the Heart of the story. The complexity, uniqueness and desire of each of the characters is compared those with the final key words selected. The method preferably includes writing about each character who each character is, what makes the character unique and complex, and what the character wants, that is, the character's desire. The character with characteristics that best match the keywords of the story to be told is the Heart of the story. To determine which character best fits as the Heart of the story, the chart shown in FIG. 3B may be used to score each character against the final keywords. The scoring may be noted in the corresponding section in the series of worksheets.

Place—Selecting the Places

Once the main character is selected the next step is preferably to consider what specific places best exhibit the story. Here what is preferably considered are the character who will carry the story, the environment in which that person is most at home, that person's unique qualities and where those qualities are most evident, that is, the relevant places, situations, and objects and how their complexity inform the story. What desire, places, objects and situations best represent the need that exists for their conflict to have occurred may also be considered. The keywords selected in FIG. 4B may be used to ensure the places selected are fully represented. The keywords may also be used to filter extraneous parts of places that are not a significant part of the story.

Plot—Constructing the Story Arc

The present method employs a timeline for the story in a three act structure: beginning, middle and ending. This is the story “arc.” At the beginning of the arc is the “Hook,” that is, a unique and interesting situation that captures the audience. In the first roughly 25% of the story the central question is typically what the heart or main character is trying to accomplish, which is referred to herein as the “Ask.” The middle will typically constitute roughly 50% of the story. This is typically the majority of the story's journey. All of the subplots or underlying conflicts are typically played out in resolution of the overarching plot or conflict. At the end of the middle is typically the answer to the Ask. The Answer is typically not the end of the story, it is typically merely the end of the middle, it may also be referred to as the peak of the story.

The Ask, Acceptance and Answer may be considered to make up the Core Question, and there are preferably five steps to build out that Core Question to formulate the story arc: (1) considering the Heart; (2) determining the Heart's desire; (3) considering the potential conflicts that could block the Heart's desire; (4) building a journey for the conflict; and (5) choosing the story arc that best fits the keywords.

The last roughly 25% of the story is typically the resolution to this question. It provides the feeling of closure, and gives the viewer a feeling of satisfaction as the story ends with the “Jab,” which should provide clear reasons why the story works out the way it does, and what the people have done with the answer they have received. These points may be entered in FIG. 3E and FIG. 3F of the plot series of worksheets, filling in the portions that pertain to the overall timeline of the narrative arc.

Purpose—The Take-away.

In this pillar the message of the story may be expressed via the chosen keywords. These act as guideposts as the story is Constructed and enables the storyteller to determine whether all of the events in the story timeline are represented by one or more of the selected keywords. The chosen keywords may be noted in FIG. 4B of the purpose series of worksheets.

The terms and expressions which have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims that follow.

1. A method for Constructing a story, comprising:
Listening to one or more persons to distill information into a narrative characterized by people, places, conflict and keywords;
compiling respective lists of potential qualities of the people, places where those qualities manifest, conflicts the people may experience and keywords that apply to the people, places and conflicts;
Constructing the narrative using the lists of the qualities of the people, the places, the conflicts, and the key words to select the heart and build the arc of the story; and
expressing the identity of the people and the places, the conflicts, the keywords, the qualities and the narrative.

3. The method of claim 1, wherein expressing comprises memorializing in one or more physical manifestations.

4. The method of claim 2, wherein expressing comprises memorializing at least a portion of the identity of the people and the places, the conflicts, the keywords, the qualities and the narrative in writing.

5. The method of claim 2, wherein expressing comprises storing at least a portion of the identity of the people and the places, the conflicts, the keywords, the qualities and the narrative as computer data.

6. The method of claim 1, wherein the qualities that characterize a person include one or more unique aspects of the person, one or more desires of the person and one or more complexities of the person.

7. The method of claim 1, wherein the places include one or more time periods, physical objects, environmental locations and situations.

8. The method of claim 1, wherein the conflicts include one or more of a conflict between a person and another person, a person and self, a person and society, a person and a machine, a person and nature, and a person and the supernatural.

9. The method of claim 1, wherein more than five keywords are initially compiled and prior to Constructing the narrative the number of key words is thereafter reduced to not more than five based on one or more of the characters' strengths, what makes each character unique, what inspiration the character invokes, the characters' motivations, how the audience should react to the story, what feelings should be experienced by the audience.

10. The method of claim 1, wherein Constructing the narrative comprises choosing the heart from among the people by numerically ranking what makes each person unique, the persons' respective desires, the persons' respective complexities and the keywords associated with each person, computing a composite of all such rankings for each person, expressing those rankings and choosing the heart from among the persons based on their respective composite rankings.

11. The method of claim 9, wherein the composite ranking is a total of a given person's respective rankings.

12. The method of claim 10, wherein the person with the highest composite ranking is chosen as the heart.

13. The method of claim 1, wherein Constructing the narrative comprises determining and expressing a Hook, an Ask, an Acceptance, an Answer and a Jab for the story.

14. The method of claim 13, wherein determining the ask, the acceptance and the answer comprises choosing and expressing a conflict of the heart from among the conflicts identified for that person, and determining and expressing how the conflict is set up, how the conflict sets the heart on a journey, and the end result of the conflict.

15. The method of claim 13, further comprising determining the hook and the jab by listing more than three parts of the story than make it unique and interesting; of those parts, choosing the three most likely to make the story most attractive parts; select a beginning, middle and end of each the three chosen parts and rank them numerically as a guide to selecting the most attractive point to make at the beginning of the story as the hook and at the end of the story as the jab.

16. A series of worksheets for use by a person to Construct a story, said series of worksheets comprising:
a first portion corresponding to a Listening phase, said first portion comprising:
at least one character page having a chart thereon with spaces for the name of a character and to be inserted and for one or more unique characteristics of that character, one or more desires of that character and one or more complexities of that character to be inserted;
at least one conflicts page having a chart thereon with spaces for conflicts experienced by that character to be identified;
at least one key word page having a chart thereon with spaces for a plurality of key words associated with each character;
at least one most significant key words page having a chart thereon with spaces for at least one of the most significant key words; and
a second portion corresponding to a Constructing phase, said second portion comprising:
at least one ranking page for entering rankings of characteristics of a plurality of characters;
at least one page having a chart for recording the lead character with that character's most significant characteristics;
at least one page having a chart for entering the time, place and environment in which the lead character lives; and
at least one page having a chart for entering a sequence of steps from conflict to resolution of the story.

17. A method for teaching a student how to Construct a story, comprising:
providing a graphical representation of a Listening phase and a Constructing phase;
providing a series of worksheets having a first portion corresponding to a Listening phase, said first portion comprising:
at least one character page having a chart thereon with spaces for the name of a character and to be inserted and for one or more unique characteristics of that character, one or more desires of that character and one or more complexities of that character to be inserted;
at least one conflicts page having a chart thereon with spaces for conflicts experienced by that character to be identified;
at least one key word page having a chart thereon with spaces for a plurality of key words associated with each character;
at least one key word page having a chart thereon with spaces for a plurality of key words associated with each character;
at least one most significant key words page having a chart thereon with spaces for at least one of the most significant key words; and
a second portion corresponding to a Constructing phase, said second portion comprising:
at least one ranking page for entering rankings of characteristics of a plurality of characters;
at least one page having a chart for recording the lead character with that character's most significant characteristics;
at least one page having a chart for entering the time, place and environment in which the lead character lives;
at least one page having a chart for entering a sequence of steps from conflict to resolution of a story, and
guiding the student through the use of the booklet.
